(19) United States
(12) Patent Application Publication
(10) Pub. No.: US 2024/0341531 A1
(43) Pub. Date: Oct. 17, 2024

(54) TWIST OFF CONTAINER AND COUPLING ASSEMBLY FOR A MICRO PUREE MACHINE

(71) Applicant: SharkNinja Operating LLC, Needham, MA (US)

(72) Inventor: Nathan Lyell, Woking (GB)

(73) Assignee: SharkNinja Operating LLC, Needham, MA (US)

(21) Appl. No.: 18/678,099

(22) Filed: May 30, 2024

Related U.S. Application Data
(62) Division of application No. 18/089,700, filed on Dec. 28, 2022, now Pat. No. 12,048,395.

(51) Int. Cl. A47J 43/07

(52) U.S. Cl. CPC A47J 43/0705

(57) ABSTRACT

A twist off container and coupling assembly of a micro puree machine includes a container and a coupling on the micro puree machine. An interior surface of the coupling has at least one ramped slot that is angled relative to a lower annular surface of the coupling. The container has at least one protrusion correspondingly angled relative to an upper annular surface of the container. The protrusion is configured to engage the slot when the container is rotated in a clockwise direction and to disengage from the slot when the container is rotated in a counterclockwise direction. When the container is rotated, the container moves both axially and rotationally relative to the coupling.

### CROSS-REFERENCE TO RELATED APPLICATIONS

This application is a divisional of U.S. application Ser. No. 18/089,700, filed Dec. 28, 2022, entitled TWIST OFF CONTAINER AND COUPLING ASSEMBLY FOR A MICRO PUREE MACHINE, the entire contents of which are incorporated herein by reference for all purposes.

### FIELD OF THE INVENTION

The present disclosure relates to a twist-off container and coupling assembly for a food processing device and, more particularly, to a twist-off container and coupling assembly for a micro puree machine for making frozen foods and drinks.

### BACKGROUND

Home use machines that are intended to make ice creams, gelatos, frozen yogurts, sorbets and the like are known in the art. Typically, a user adds a series of non-frozen ingredients to a container. The ingredients are then churned by a paddle while a refrigeration mechanism simultaneously freezes the ingredients. These devices have known shortcomings including, but not limited to, the amount of time and effort required by the user to complete the ice cream making process. Machines of this nature are also impractical for preparing most non-dessert food products.

An alternative type of machine known to make a frozen food product is a micro-puree machine. Typically, machines of this nature spin and plunge a blade into a pre-frozen ingredient or combination of ingredients. While able to make frozen desserts like ice creams, gelatos, frozen yogurts, sorbets and the like, micro puree style machines can also prepare non-dessert types of foods such as non-dessert purees and mousses. In addition, consumers can prepare either an entire batch of ingredients or a pre-desired number of servings.

In some micro puree machines, a lid housing the blade couples to the container of ingredients. To install the container on the machine, the user rotates the container relative to a coupling on the machine, which in turn rotates the lid into the coupling. The blade then engages a power shaft of the machine to spin and plunge the blade into the ingredients. However, in some cases when blending frozen ingredients, the blade may become stuck to the power shaft due to a build-up of ice between the blade and the power shaft. When this occurs, the user must use a significant force to rotate the container in the opposite direction to uncouple it from the machine.

### SUMMARY

The disclosure describes a twist off container and coupling assembly of a micro puree machine which allows for gentle disengagement of the container from the machine when ice has formed between the blade and the power shaft of the machine. The assembly includes a container and a coupling on the micro puree machine. An interior surface of the coupling has at least one ramped slot that is angled relative to a lower annular surface of the coupling. The container also has at least one protrusion correspondingly angled relative to an upper annular surface of the container. The protrusion is configured to engage the slot when the container is rotated in a clockwise direction and to disengage from the slot when the container is rotated in a counterclockwise direction. When the container is rotated, the container moves both axially and rotationally relative to the coupling, allowing the blade to disengage from the power shaft with less force than if the container could only move rotationally relative to the coupling.

Embodiments of the twist off container and coupling assembly of this disclosure may include one or more of the following, in any suitable combination.

Embodiments of the twist off container and coupling assembly of a micro puree machine of this disclosure include a container having at least one protrusion on an outer surface of the container. A coupling on the micro puree machine has at least one ramped slot on an interior surface of the coupling. The at least one ramped slot is angled relative to a lower annular surface of the coupling. The at least one protrusion is configured to slidably engage the at least one ramped slot when the container is rotated in a first direction. The at least one protrusion is correspondingly angled relative to an upper annular surface of the container such that, when the container is rotated in the first direction, the container moves both axially and rotationally relative to the coupling.

In further embodiments, the at least one ramped slot and the at least one protrusion form a helical bayonet mount. In embodiments, the at least one protrusion is two protrusions, and the at least one ramped slot is two ramped slots. Each of the two protrusions are configured to slidably engage a respective one of each of the two ramped slots. In embodiments, the two protrusions are positioned on opposing sides of the outer surface of the container. In other embodiments, the at least one protrusion is four protrusions, and the at least one ramped slot is four ramped slots. Each of the four protrusions are configured to slidably engage a respective one of each of the four ramped slots. In embodiments, the four protrusions are equally spaced apart about the outer surface of the container. In embodiments, a container axis extending between a top and a bottom of the container is not vertically aligned with a vertical axis of the micro puree machine when the container is locked to the coupling. In embodiments, the container axis forms an angle of between 1 and 180 degrees with respect to the vertical axis of the micro puree machine. In other embodiments, the container axis forms an angle of between 45 and 55 degrees with respect to the vertical axis of the micro puree machine. In embodiments, the assembly further includes a lid coupled to the container. In embodiments, the lid is configured to house a blade of the micro puree machine.

Embodiments of a coupling of a micro puree machine of this disclosure include a coupling body having an inner surface. The coupling body also includes at least one ramped slot on the interior surface of the coupling. The at least one ramped slot is angled relative to a lower annular surface of the coupling body. The at least one ramped slot forms a part of a helical bayonet mount. In embodiments, the at least one ramped slot is two ramped slots positioned on opposite sides of the inner surface of the coupling. In other embodiments, the at least one ramped slot is four ramped slots equally spaced apart about the inner surface of the coupling.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1 shows a micro puree machine according to some embodiments of this disclosure;

FIG. 2 shows the micro puree machine of FIG. 1 with the container disengaged from the machine according to some embodiments;

FIGS. 3A and 3B illustrate rotation of the container into the coupling of the micro puree machine, according to some embodiments;

FIGS. 3C and 3D illustration rotation of the container out of the coupling of the micro puree machine, according to some embodiments;

FIGS. 4A-C illustrate components of a bowl lock assembly, according to some embodiments;

FIGS. 5A-D illustrate a method of using the bowl lock assembly of FIGS. 4A-C to lock and unlock the container from the micro puree machine, according to some embodiments;

FIGS. 6A-E illustrate components of an alternate bowl lock assembly of this disclosure according to some embodiments; and

FIGS. 6F and 6G illustrate a method of using the bowl lock assembly of FIGS. 6A-E to lock and unlock the container from the micro puree machine, according to some embodiments.

### DETAILED DESCRIPTION

In the following description, like components have the same reference numerals, regardless of different illustrated embodiments. To illustrate embodiments clearly and concisely, the drawings may not necessarily reflect appropriate scale and may have certain structures shown in somewhat schematic form. The disclosure may describe and/or illustrate structures in one embodiment, and in the same way or in a similar way in one or more other embodiments, and/or combined with or instead of the structures of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the twist off container and coupling in any manner.

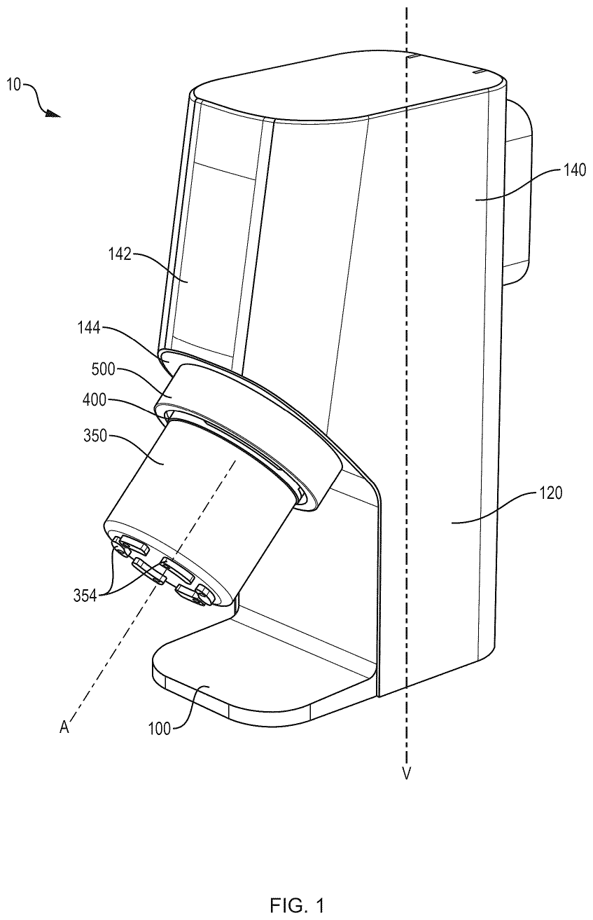

FIG. 1 shows an isometric view of a micro puree machine 10 according to an illustrative embodiment of the present disclosure. The micro puree machine 10 may include a base 100 and an upper housing 140. A middle housing 120 may extend between the base 100 and the upper housing 140. The upper housing 140 may include an interface 142 for receiving user inputs to control the micro puree machine 10 and/or display information. The micro puree machine 10 may also include a removable container 350 and a lid 400. The container 350 may contain one or more pre-frozen ingredients for processing. A user may couple the container 350 to a coupling 500 on an angled surface 144 of the upper housing 140 by rotating the container 350 relative to the coupling 500, as further described below. When engaged with the coupling 500, the container 350 may not be aligned with a vertical axis V of the micro puree machine 10. Instead, a container axis A extending between a top and bottom of the container 350 may form an angle of between 1 degree and 180 degrees with respect to the vertical axis V. Preferably, the container axis A forms an angle of about 45 degrees to about 55 degrees relative to the vertical axis V. In embodiments, the container 350 may include features 354 on the bottom surface of the container 350 to aid in the fixing of frozen ingredients within the container 350. The features 354 may prevent such frozen ingredients from rotational movement within the container 350 during use. In embodiments, the container 350 can be manufactured from a disposable material to enhance the convenience of using the micro puree machine 10. Further, the container 350 can be sold as a stand-alone item and can also be prefilled with ingredients to be processed during use of the micro puree machine 10.

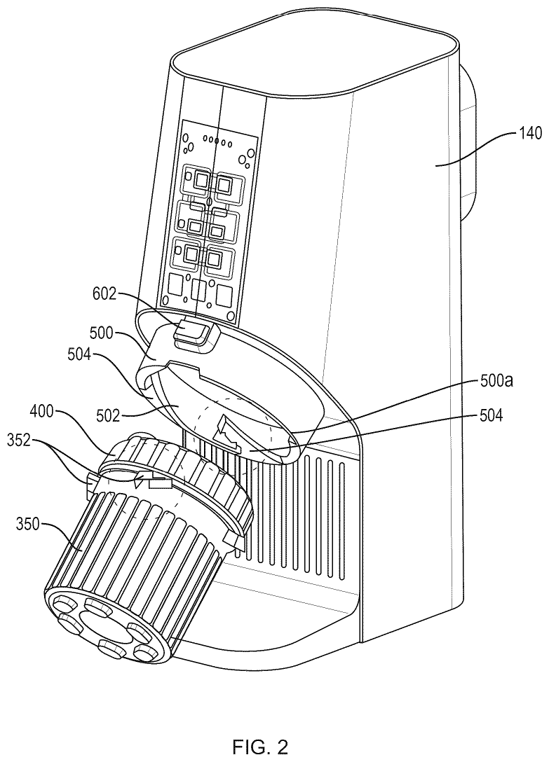

FIG. 2 shows the micro puree machine 10 of FIG. 1 with the container 350 and the lid 400 disassembled from the coupling 500 according to some embodiments. As shown in FIG. 2, the coupling 500 may comprise a button 602 for unlocking the container 350 from the coupling 500 as further described below. In embodiments, an inner surface 502 of the coupling 500 may also comprise locating and locking elements for positioning and connecting the container 350 to the coupling 500. For example, the inner surface 502 of the coupling 500 may comprise one or more slots 504 sized to receive at least one corresponding protrusion 352 on an outer surface of the container 350. In some embodiments, the at least one protrusion 352 may be two protrusions 352 spaced on opposing sides of an outer surface of the container 350 and configured to engage two corresponding slots 504 on the coupling 500. In other embodiments, the at least one protrusion 352 may be four protrusions 352 spaced equally apart about an outer surface of the container 350 and configured to engage four corresponding slots 504 on the coupling 500. However, the disclosure contemplates more or fewer than two or four protrusions 352 and slots 504. The disclosure also contemplates that the protrusions may be positioned on the lid 400, rather than the container 350. In embodiments, the slots 504 may be angled and extend in a helical manner relative to an annular lower surface 500a of the coupling 500. Similarly, the protrusions 352 may be correspondingly angled relative to an upper annular surface 350a of the container 350. In embodiments, insertion of the protrusions 352 into the slots 504 may form a bayonet-type mount.

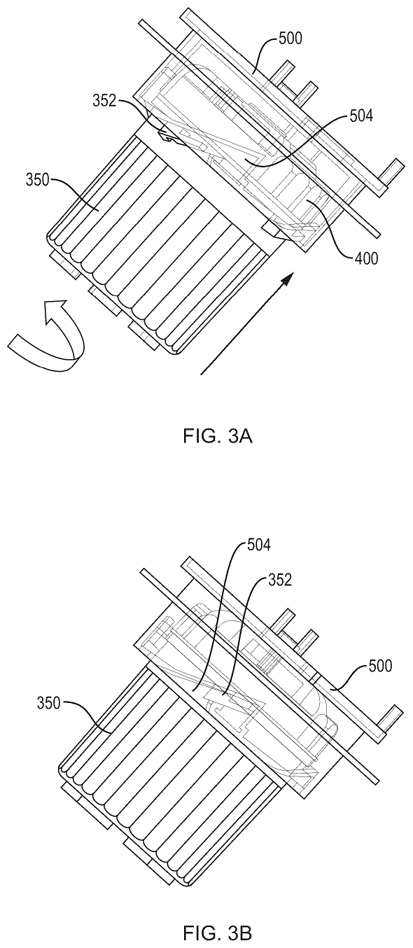

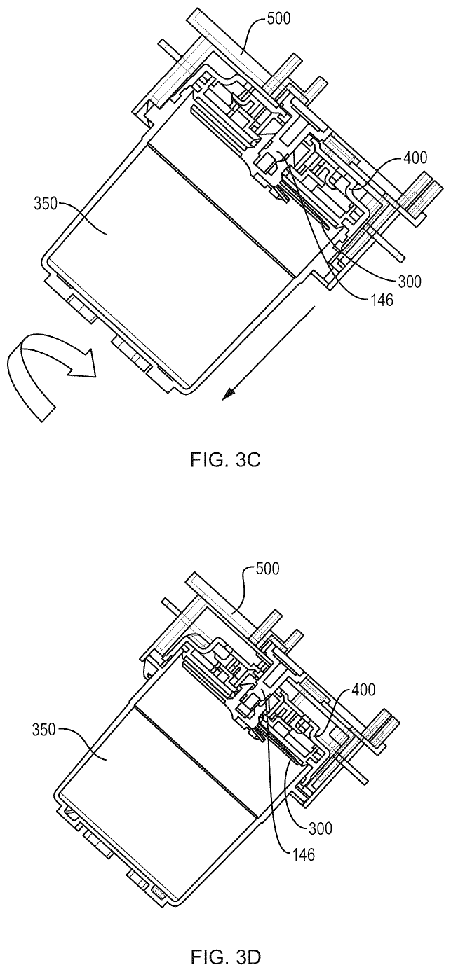

FIG. 3A shows the container 350 inserted into the coupling 500 (shown in a transparent view for case of illustration) but before the container 350 is secured to the coupling 500 according to some embodiments. As shown in FIG. 3A, the user may rotate the container 350 relative to the coupling 500 in a first direction (e.g., clockwise) such that the protrusions 352 rotate into the slots 504, securing the container 350 to the coupling 500 (FIG. 3B). Because of the angle of the slots 504 and the protrusions 352, rotating the container 350 relative to the coupling 500 may cause the container 350 to move both rotationally and axially within the coupling 500.

FIG. 3C shows a cross-sectional view of the container 350 secured to the coupling 500 according to some embodiments. As shown in FIG. 3C, the lid 400 may house a blade 300 that engages a power shaft 146 when the container 350 is secured to the coupling 500. When blending frozen ingredients, an ice wall may form between the power shaft 146 and the blade 300, requiring a greater force to disengage the blade 300 from the power shaft 146. However, as shown in FIG. 3D, as the user rotates the container 350 relative to the coupling 500 in a second direction (e.g., counterclockwise) to disengage the container 350 from the coupling 500, the container 350 may move both rotationally and axially away from the coupling 500. This rotational and axial movement may advantageously allow the blade 300 to disengage from power shaft 146 using less force than would be needed if the container 350 could only move rotationally relative to the coupling 500.

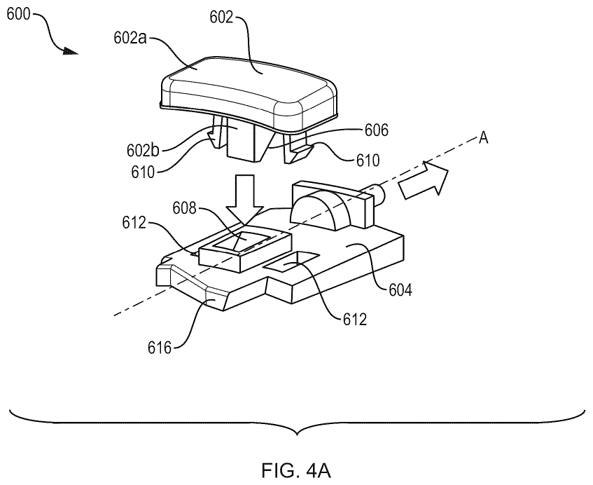

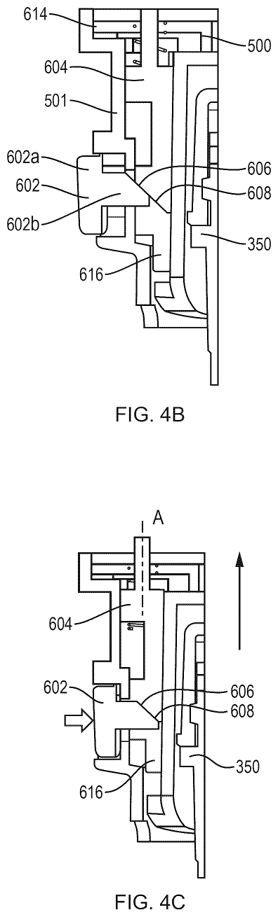

FIGS. 4A-C illustrate components of a bowl lock assembly 600 of this disclosure according to some embodiments. As shown in FIG. 4A, the bowl lock assembly 600 may comprise the button 602 and a moveable clip 604. The button 602 may comprises a first portion 602a and a second portion 602b having a first angled surface 606. The button 602 may be assemblable to the clip 604 through flexures 610 configured to engage corresponding slots 612 on the clip 604. The first angled surface 606 may be configured to engage a second angled surface 608 on the clip 604 such that actuating the first portion 602a of the button 602 (such as by pressing) toward the clip 604 causes the clip 604 to move along the container axis A. A projection 616 on the clip 604 may be configured to engage the protrusions 352, as further described below.

As shown in FIG. 4B, the button 602 may extend through an outer wall 501 of the coupling 500 such that the first portion 602a is engageable by a user while the second portion 602b extends into the interior of the coupling 500. The clip 604 may be positioned within the interior of the coupling 500 and may be biased by a spring 614 or other biasing element toward a locked position, as shown. When the container 350 is in the locked position (that is, when the protrusions 352 have been fully rotated into the slots 504 of the coupling 500), the first angled surface 606 of the button 602 may only partially engage the second angled surface 608 on the clip 604. In this position, the projection 616 on the clip 604 may prevent the protrusions 352 from rotating out of the slots 504. As shown in FIG. 4C, when the user presses the button 602, the first angled surface 606 may fully engage the second angled surface 608 on the clip 604, moving the clip 604 along the container axis A against the force the spring 614. In this position, the projection 616 may no longer prevent the protrusions 352 from rotating out of the slots 504, allowing the user to rotate the container 350 out of the coupling 500.

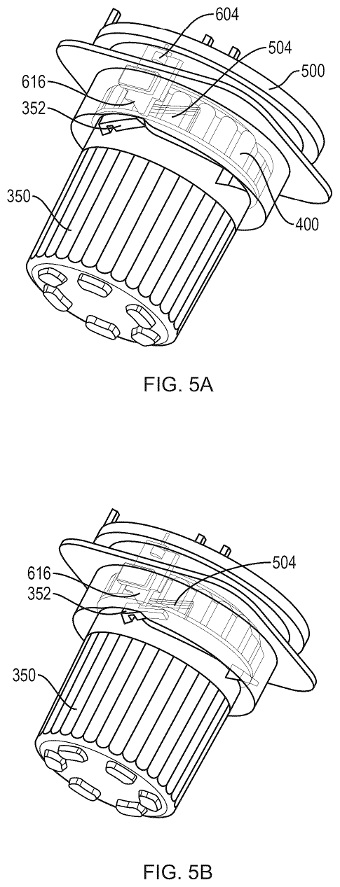

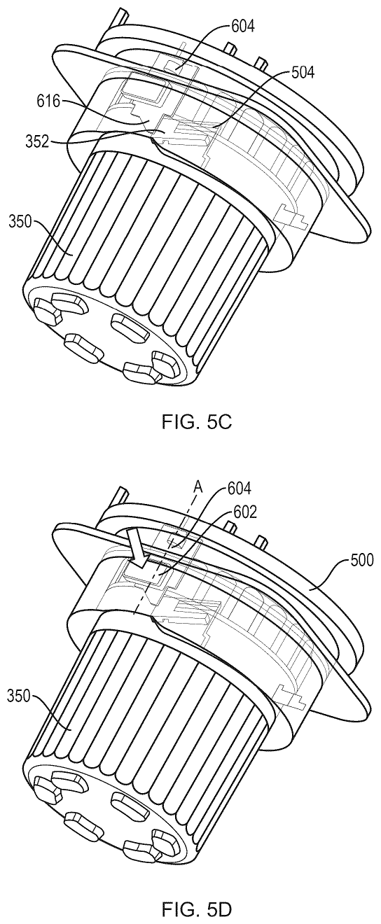

FIGS. 5A-D illustrate a method of locking and unlocking the container 350 from the coupling 500 using the locking assembly 600, according to some embodiments. As shown in FIG. 5A, the user may first insert the container 350 into the coupling 500 such that the protrusions 352 align with the slots 504 on the coupling 500. In this relative position of the container 350 and the coupling 500, the clip 604 may be biased by the spring 614 in the downward position. As shown in FIG. 5B, the user may rotate the container 350 in a first direction (e.g., clockwise) such that the protrusions 352 begin to rotate into the slots 504. As the protrusion 352 rotates past the clip 604, the protrusion 352 pushes the clip 604 upwards against the force of the spring 614. As shown in FIG. 5C, as the user continues to rotate the container 350, the protrusion 352 may rotate passed the projection 616 on the clip 604. Once the protrusion 352 is clockwise of the projection 616, the spring 614 may cause the projection 616 to move downward, preventing the protrusion 352 from being rotated counterclockwise out of the slot 504. As shown in FIG. 5D, when the user wishes to remove the container 350 from the coupling 500, the user may actuate the button 602 to move the clip 604 upwards along the container axis A such that it no longer blocks the protrusion 352 from rotating counterclockwise. This allows the user to rotate the container 350 counterclockwise out of the coupling 500.

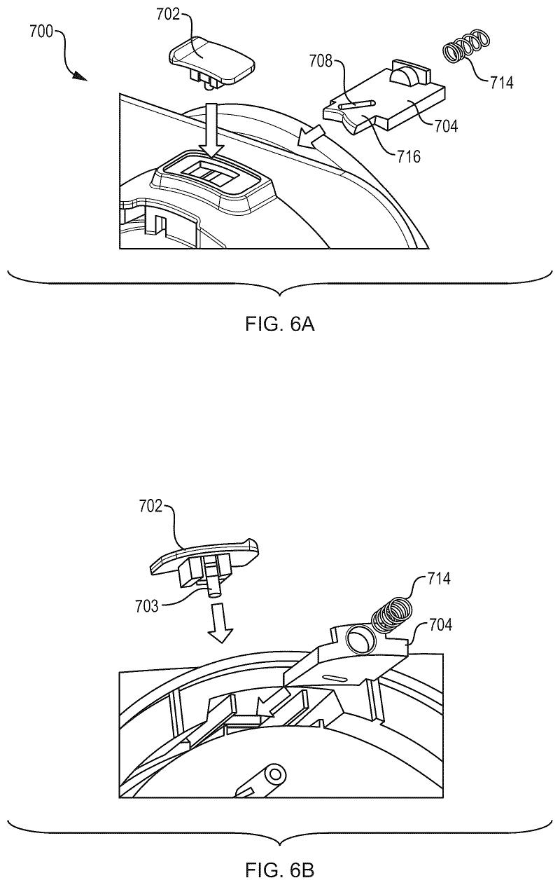

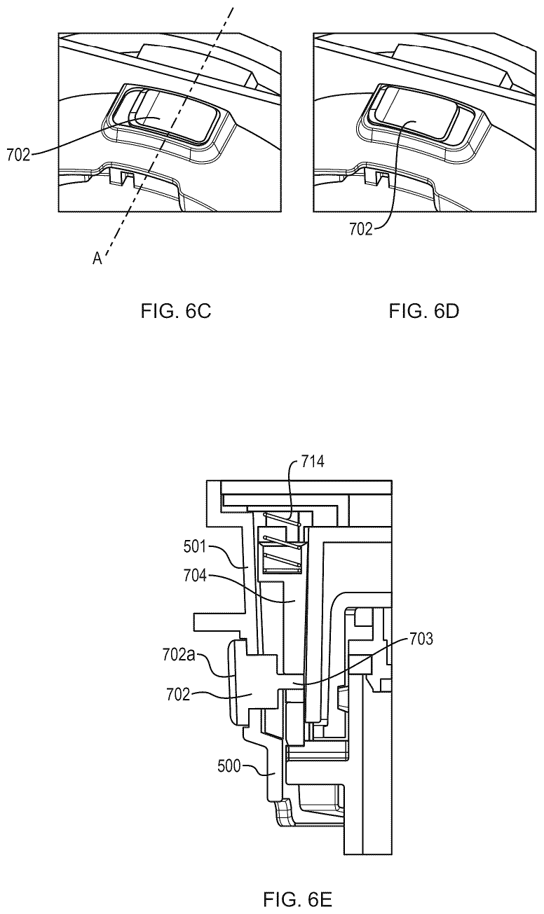

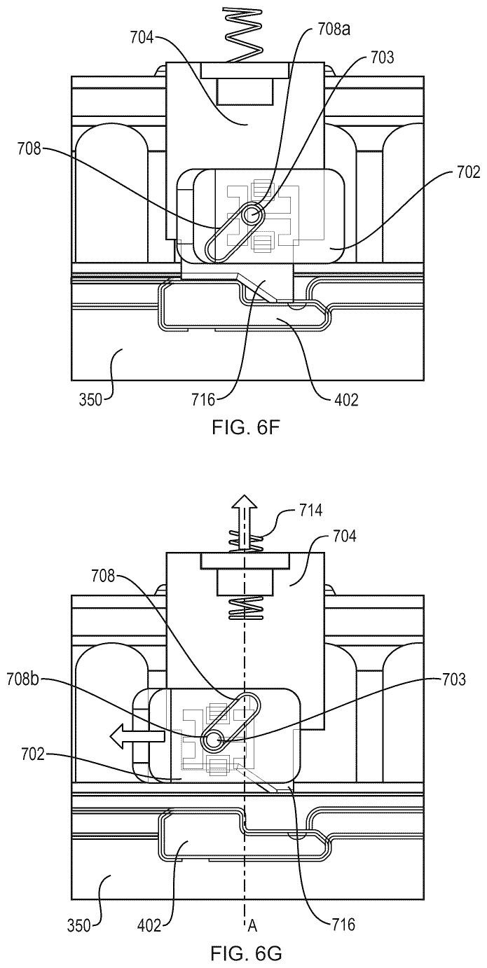

FIGS. 6A-G illustrate an alternate bowl lock assembly 700 of this disclosure according to some embodiments. As shown in FIG. 6A, the bowl lock assembly 700 may comprise a button 702 and a moveable clip 704. The button 702 may comprises a pin 703 (FIG. 6B) configured to engage an angled slot 708 on the clip 704. A projection 716 on the clip 704 may be configured to engage the protrusions 702 on the container 350. In embodiments, sliding the button 702 along an axis perpendicular to the container axis A from a locked position (FIG. 6C) to an unlocked position (FIG. 6D) may cause the clip 704 to move along the container axis A. As shown in FIG. 6E, the button 702 may extend through an outer wall 501 of the coupling 500 such that a first portion 702a is slidable by a user while the pin 703 extends into the interior of the coupling 500. The clip 704 may be positioned in the interior of the coupling 500 and may be biased by a spring 714 or other biasing element toward a locked position.

FIGS. 6F and 6G illustrate a method of locking and unlocking the container 350 from the coupling 500 using the locking assembly 700, according to some embodiments. As shown in FIG. 6F, when the container 350 is in the locked position (that is, when the protrusions 352 have been fully rotated into the slots 504 of the coupling 500), the pin 703 of the button 702 may be positioned in an upper end 708a of the angled slot 708. In this position, the projection 716 on the clip 704 may prevent the protrusions 352 from rotating out of the slots 504. As shown in FIG. 6G, when the user slides the button 702 along an axis perpendicular to the container axis A, the pin 703 also moves to the lower end 708b of the angled slot 708. This movement of the pin 703 may cause the clip 704 to move along the container axis A against the force the spring 714. In this position of the clip 704, the projection 716 may no longer prevent the protrusions 352 from rotating out of the slots 504, allowing the user to rotate the container 350 out of the coupling 500.

While the disclosure particularly shows and describes preferred embodiments, those skilled in the art will understand that various changes in form and details may exist without departing from the spirit and scope of the present application as defined by the appended claims. The scope of this present application intends to cover such variations. As such, the foregoing description of embodiments of the present application does not intend to limit the full scope conveyed by the appended claims.

1. A coupling of a micro puree machine, the coupling comprising:
a coupling body having an inner surface, the coupling body further comprising at least one ramped slot on the interior surface of the coupling body, the at least one ramped slot being angled relative to a lower annular surface of the coupling body;
wherein the at least one ramped slot forms a part of a helical bayonet mount.

2. The coupling of claim 1, wherein the at least one ramped slot is two ramped slots positioned on opposite sides of the inner surface of the coupling body.

3. The coupling of claim 1, wherein the at least one ramped slot is four ramped slots equally spaced apart about the inner surface of the coupling body.

4. The coupling of claim 1, wherein the at least one ramped slot is configured to slidably engage at least one protrusion on a container when the container is rotated in a first direction relative to the coupling.

5. The coupling of claim 4, wherein the coupling is configured to couple the container to the micro puree machine such that a container axis extending between a top and a bottom of the container extends at an angle with respect to a vertical axis of the micro puree machine, the vertical axis of the micro puree machine extending perpendicular to a bottom surface of the micro puree machine.

6. The coupling of claim 5, wherein the angle is between 1 and 180 degrees.

7. The coupling of claim 5, wherein the angle is between 45 and 55 degrees.

8. The coupling of claim 4, wherein the coupling further comprises a user-actuatable button on an outer surface of the coupling, the user-actuatable button configured to allow the container to rotate in a second direction opposite the first direction when the button is actuated by a user.

9. The coupling of claim 4, wherein the coupling is configured to allow the container to move both axially and rotationally relative to the coupling when the container is rotated in the first direction.

10. The coupling of claim 1, wherein an opening of the at least one slot defining a portion in contact with the lower annular surface of the coupling.
